(19) United States
(12) Patent Application Publication
(10) Pub. No.: US 2024/0193646 A1
(43) Pub. Date: Jun. 13, 2024

(54) COMPUTER-IMPLEMENTED SYSTEM AND METHOD FOR PRICE MANAGEMENT

(71) Applicants: Pravin Dayaram PATIL, Mumbai, IN (US); Amrit Vishno SADANI, Morganville, NJ (US); Sanmati JAIN, Khanpur (IN); Manishkumar Subhashchandra TIWARI, Thane (IN)

(72) Inventors: Pravin Dayaram PATIL, Mumbai, IN (US); Amrit Vishno SADANI, Morganville, NJ (US); Sanmati JAIN, Khanpur (IN); Manishkumar Subhashchandra TIWARI, Thane (IN)

(21) Appl. No.: 18/528,853

(22) Filed: Dec. 5, 2023

Related U.S. Application Data
(60) Provisional application No. 63/430,893, filed on Dec. 7, 2022.

(51) Int. Cl. G06Q 30/0283

(52) U.S. Cl. CPC G06Q 30/0283

(57) ABSTRACT

Disclosed are systems and methods for managing the pricing of various assets. The current systems and methods introduce a price reduction mechanism that raises the selling price of the asset while lowering the purchase price. The pricing approach of the present invention benefits both sellers and buyers. The positive stripping pricing mechanism decreases the asset value for the buyer, while the negative stripping pricing mechanism potentially raises the selling price of the asset. This way, sellers can secure a higher amount from the sale, and buyers can achieve a lower purchase cost.

### BACKGROUND

### Technical Field

The invention presented herein is generally directed toward systems and methods for managing the pricing of various assets. More particularly, a price reduction mechanism that increases the sale price of the asset with a reduced purchase price.

### Description of the Related Art

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

In a traditional market auction, the setup is typically structured in a way that primarily advantages the seller. This advantage stems from a mechanism that causes the value of the asset to rise as more interest and competition among potential buyers emerge. However, this conventional auction mechanism tends to work against the interests of the buyers. As the interest in the asset grows and the competition intensifies, the price of the asset steadily climbs, ultimately resulting in an unfavorable situation for the buyer.

This specification recognizes that there is a need for a system and method for managing the pricing of various assets by providing a price reduction mechanism that increases the sale price of the asset with a reduced purchase price.

Thus, in view of the above, there is a long-felt need in the industry to address the aforementioned deficiencies and inadequacies.

Further limitations and disadvantages of conventional approaches will become apparent to one of skill in the art through the comparison of described systems with some aspects of the present disclosure, as set forth in the remainder of the present application and with reference to the drawings.

### SUMMARY

Systems and methods for managing the pricing of various assets are provided, as shown in and/or described in connection with at least one of the figures.

One aspect of the present disclosure relates to a system for managing the pricing of various assets. The system includes a processor; and a memory. The memory is communicatively coupled to the processor. The memory stores a plurality of instructions, which, on execution, causes the processor to a) initiate a pricing management process for the one or more assets. The processor is configured to b) enable the participation of one or more users. The processor is configured to c) determine interest of the one or more users in purchasing the one or more assets. The processor is configured to c1) allow the one or more users to exit the pricing management process upon determining disinterest of the one or more users in purchasing the one or more assets. In response to determining interest of the one or more users in purchasing, the processor is configured to d) provide an option to the one or more users to reveal a concealed price through one or more of: a positive stripping process, and a negative stripping process. The processor is configured to e) determine willingness of the one or more users to unveil the concealed price. In response to determine willingness of the one or more users to unveil the concealed price, the processor is configured to f) require the one or more users to make a payment of a pre-determined fraction of the listed price to access the concealed price for a limited duration of ‘t’ seconds. In an aspect, the pre-determined fraction of the listed price, whether fixed or variable, can be used to reveal a hidden price. It is important to note that “fraction” can represent either a static or dynamic value. The processor is configured to g) execute the payment of the pre-determined fraction of credits in step f). The processor is configured to h) record the credits in one or more of: a centralized ledger book, and a decentralized ledger book associated with a marketplace. The processor is configured to i) adjust the price of the asset based on the accumulated credits from step g). The accumulated credits reduce the asset's price by a corresponding amount. The processor is configured to j) verify whether the adjusted discounted price in step i) exceeds a predefined maximum discount limit set for the asset. The processor is configured to k) enable continued participation of the one or more users in the positive stripping process while progressively reducing the asset's price with successive stripping actions upon determining that the predefined maximum discount limit has not been reached. The processor is configured to l) render the positive stripping process with dynamic pricing void and commence the negative stripping process upon determining that the predefined maximum discount limit has been reached. The processor is configured to m) implement the negative stripping process to prevent the discounted price from decreasing below the last stripped price obtained through the positive stripping process, thereby maintaining a static price. The processor is configured to n) calculate surplus credits accrued through the negative stripping process in either the centralized ledger book or the decentralized ledger book. The processor is configured to o) assign the surplus credits, if any, to a seller in exchange for a successful transfer of ownership of the asset to a buyer. The processor is configured to p) inquire the one or more users about their intent to purchase the assets at a presently displayed discounted price. The processor is configured to p1) allow the one or more users to exit the pricing management process upon determining the declination of the purchase by the one or more users. Responsive to the one or more users agreeing to the purchase, the processor is configured to q) facilitate initiation of the purchase process for the one or more users. The processor is configured to r) determine the availability of the assets during the purchase process to determine if the asset is still available for acquisition. The processor is configured to s) verify the availability of sufficient credits with the one or more users upon determining if the asset is still available. The processor is configured to t) confirm the transaction and transfer the accumulated credits, via the positive stripping process and the negative stripping processes, to the seller's account, upon payment approval. The processor is configured to u) transfer ownership of the asset to the one of the one or more users who has completed the purchase process. In a scenario where multiple users initiate the “purchase” process for a “single asset”, only the transaction of the user whose payment is successfully processed will result in the acquisition of the product. For the remaining users, their transactions will fail, and they will not be able to obtain the product. The processor is configured to e1) provide an option to the one or more users to acquire the asset at a listed price, and proceed to step r) to step u) upon determining unwillingness of the one or more users to unveil the concealed price. The processor is configured to r1) exit the pricing management process with a display of a pre-stored message upon determining the unavailability of the asset. For example, the displayed pre-stored message can be “Asset has already been sold”.

Another aspect of the present disclosure relates to a method for managing the pricing of one or more assets. The method includes a step of a) initiating, by a processor, a pricing management process for the one or more assets. The method includes a step of b) enabling, by the processor, participation of one or more users. The method includes a step of c) determining, by the processor, interest of the one or more users in purchasing the one or more assets. The method includes a step of d) responsive to determining, by the processor, interest of the one or more users in purchasing, providing an option to the one or more users to reveal a concealed price through one or more of: a positive stripping process, and a negative stripping process. The method includes steps of: e) determining, by the processor, willingness of the one or more users to unveil the concealed price; f) responsive to determining, by the processor, willingness of the one or more users to unveil the concealed price, requiring the one or more users to make a payment of a pre-determined fraction of the listed price to access the concealed price for a limited duration of ‘t’ seconds; and g) executing, by the processor, the payment of the pre-determined fraction of credits in step f). The method includes a step of h) recording, by the processor, the credits in one or more of: a centralized ledger book, and a decentralized ledger book associated with a marketplace. The method includes a step of i) adjusting, by the processor, the price of the asset based on the accumulated credits from step g), wherein the accumulated credits reduce the asset's price by a corresponding amount. The method includes a step of j) verifying, by the processor, whether the adjusted discounted price in step i) exceeds a predefined maximum discount limit set for the asset. The method includes a step of k) if the predefined maximum discount limit has not been reached, enabling, by the processor, continued participation of the one or more users in the positive stripping process while progressively reducing the asset's price with successive stripping actions. The method includes a step of l) if the predefined maximum discount limit has been reached, rendering, by the processor, the positive stripping process with dynamic pricing void and commencing the negative stripping process. The method includes a step of m) implementing, by the processor, the negative stripping process to prevent the discounted price from decreasing below the last stripped price obtained through the positive stripping process, thereby maintaining a static price. The method includes a step of n) calculating, by the processor, surplus credits accrued through the negative stripping process in one or more of: the centralized ledger book, and the decentralized ledger book. The method includes a step of o) assigning, by the processor, the surplus credits, if any, to a seller in exchange for a successful transfer of ownership of the asset to a buyer. The method includes a step of p) inquiring, by the processor, the one or more users about their intent to purchase the assets at a presently displayed discounted price. When the one or more users agree to the purchase, the method includes a step of q) facilitating, by the processor, initiation of the purchase process for the one or more users. The method includes a step of r) determining, by the processor, the availability of the assets during the purchase process to determine if the asset is still available for acquisition. If the asset is still available, the method includes a step of s) verifying, by the processor, the availability of sufficient credits with the one or more users. Upon payment approval, the method includes a step of t) confirming the transaction, by the processor, and transferring the accumulated credits, via the positive stripping process and the negative stripping processes, to the seller's account. The method includes a step of u) transferring, by the processor, ownership of the asset to the one of the one or more users who has completed the purchase process. The method includes a step of c1) responsive to determining, by the processor, disinterest of the one or more users in purchasing the one or more assets, allowing the one or more users to exit the pricing management process. Responsive to determining unwillingness of the one or more users to unveil the concealed price, the method includes a step of e1), providing an option to the one or more users to acquire the asset at a listed price, and proceeding to step r) to step u). Responsive to determining the declination of the purchase by the one or more users, the method includes a step of: p1) allowing the one or more users to exit the pricing management process. If the asset is unavailable, the method includes a step of: r1) exiting the pricing management process with a display of a pre-stored message upon determining the unavailability of the asset.

Another aspect of the present disclosure relates to a non-transitory computer-readable storage medium in a distributed computing system, the non-transitory computer-readable storage medium having instructions stored thereupon which, when executed by a processor, cause the processor to a) initiate a pricing management process for the one or more assets. The processor is configured to b) enable the participation of one or more users. The processor is configured to c) determine interest of the one or more users in purchasing the one or more assets. In response to determining interest of the one or more users in purchasing, the processor is configured to d) provide an option to the one or more users to reveal a concealed price through one or more of: a positive stripping process, and a negative stripping process. The processor is configured to e) determine willingness of the one or more users to unveil the concealed price. In response to determine willingness of the one or more users to unveil the concealed price, the processor is configured to f) require the one or more users to make a payment of a pre-determined fraction of the listed price to access the concealed price for a limited duration of ‘t’ seconds. The processor is configured to g) execute the payment of the pre-determined fraction of credits in step f). The processor is configured to h) record the credits in one or more of: a centralized ledger book, and a decentralized ledger book associated with a marketplace. The processor is configured to i) adjust the price of the asset based on the accumulated credits from step g). The accumulated credits reduce the asset's price by a corresponding amount. The processor is configured to j) verify whether the adjusted discounted price in step i) exceeds a predefined maximum discount limit set for the asset. The processor is configured to k) enable continued participation of the one or more users in the positive stripping process while progressively reducing the asset's price with successive stripping actions upon determining that the predefined maximum discount limit has not been reached. The processor is configured to l) render the positive stripping process with dynamic pricing void and commence the negative stripping process upon determining that the predefined maximum discount limit has been reached. The processor is configured to m) implement the negative stripping process to prevent the discounted price from decreasing below the last stripped price obtained through the positive stripping process, thereby maintaining a static price. The processor is configured to n) calculate surplus credits accrued through the negative stripping process in either the centralized ledger book or the decentralized ledger book. The processor is configured to o) assign the surplus credits, if any, to a seller in exchange for a successful transfer of ownership of the asset to a buyer. The processor is configured to p) inquire the one or more users about their intent to purchase the assets at a presently displayed discounted price. Responsive to the one or more users agreeing to the purchase, the processor is configured to q) facilitate initiation of the purchase process for the one or more users. The processor is configured to r) determine the availability of the assets during the purchase process to determine if the asset is still available for acquisition. The processor is configured to s) verify the availability of sufficient credits with the one or more users upon determining if the asset is still available. The processor is configured to t) confirm the transaction and transfer the accumulated credits, via the positive stripping process and the negative stripping processes, to the seller's account, upon payment approval. The processor is configured to u) transfer ownership of the asset to the one of the one or more users who has completed the purchase process. The processor is configured to c1) allow the one or more users to exit the pricing management process upon determining disinterest of the one or more users in purchasing the one or more assets. The processor is configured to e1) provide an option to the one or more users to acquire the asset at a listed price, and proceed to step r) to step u) upon determining unwillingness of the one or more users to unveil the concealed price. The processor is configured to p1) allow the one or more users to exit the pricing management process upon determining the declination of the purchase by the one or more users. The processor is configured to r1) exit the pricing management process with a display of a pre-stored message upon determining the unavailability of the asset.

Other embodiments and advantages will become readily apparent to those skilled in the art upon viewing the drawings and reading the detailed description hereafter, all without departing from the scope of the disclosure. The drawings and detailed descriptions presented are to be regarded as illustrative in nature and not in any way as restrictive.

Other features of the example embodiments will be apparent from the drawings and from the detailed description that follows.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 is a block diagram that illustrates a system environment in which various embodiments of the present method and the system may be implemented.

FIG. 2 is a block diagram that illustrates a server configured to manage the pricing of one or more assets, in accordance with at least one embodiment.

FIGS. 3A-3B are operational flowcharts of the present method, in accordance with at least one embodiment.

FIGS. 4A-4B illustrate flowcharts of a method for managing the pricing of one or more assets, in accordance with at least one embodiment.

### DETAILED DESCRIPTION

The disclosure will be described more fully hereinafter with reference to the accompanying drawings, in which example embodiments of the disclosure are shown, and not intended to be limiting.

Aspects of the present disclosure relate to a system that facilitates the reduction of the asset value with a committed predetermined fractional value of the total asset amount. The present system is beneficial to both the buyer and the seller in different ways. Using the “Positive Stripping Mechanism”, the buyer is guaranteed to receive the lowest price if the user decides to purchase the asset. Whereas the seller can receive a higher amount than the listed sale price set for the asset with the usage of the “Negative Stripping Mechanism”.

In an embodiment, the fractional value is termed as “consumed” if the buyer decides to forgo the purchase timeline. This in turn will help further reduce the asset value for the next prospective buyer.

Currently, a regular market auction is designed to benefit only the seller with the mechanism that increases the value of the asset as the interest in the asset increases. This conventional mechanism does not favor the buyer as the price of the asset increases. Due to high demand, the buyer could end up paying way more than the anticipated market value of the product. Currently, there are no sale engines that benefit both the seller and the buyer at the same time as it follows a conventional approach.

The proposed unique pricing mechanism benefits both the seller and the buyer by reducing the asset value (not increasing) for the buyer with the “Positive Stripping Pricing Mechanism”, along with the chances of increasing the sale price of the asset by “Negative Stripping Pricing Mechanism”. Thus, giving the seller a higher amount sold and the buyer with a lower purchase amount.

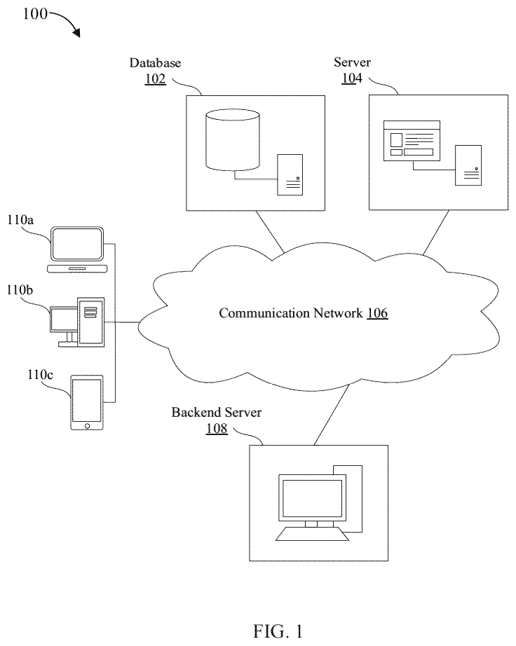

FIG. 1 is a block diagram that illustrates a system environment 100 in which various embodiments of the present method and the system may be implemented. The system environment 100 may include a database 102, a server 104, a communication network 106, a backend server 108, and one or more client devices 110a, 110b, and 110c collectively referred to as the client device 110. In an embodiment, the client device 110 is a device that is used by a user to access marketplace platforms. Examples of marketplace platforms include but are not limited to an e-commerce website or STRIPTO NFT marketplace (SNM) platform.

In an embodiment, the database 102, the server 104, the backend server 108, and the client devices 110 may be communicatively coupled with each other via the communication network 106. In an embodiment, the server 104 may communicate with the database 102 using one or more protocols such as, but not limited to, Open Database Connectivity (ODBC) protocol and Java Database Connectivity (JDBC) protocol. In an embodiment, the backend server 108, and the client device 110 may communicate with the server 104, via the communication network 106. Examples of the client device 110 may include but are not limited to, a personal computer, a laptop, a personal digital assistant (PDA), a mobile device, a tablet, or any other computing device.

In an embodiment, the database 102 may refer to a computing device that may be configured to store pricing data related to one or more assets.

In an embodiment, the database 102 may include a special-purpose operating system specifically configured to perform one or more database operations on data related to the first unique client identifier, the second unique client identifier, and the third unique client identifier. Examples of database operations may include, but are not limited to, Select, Insert, Update, and Delete. In an embodiment, the database 102 may include hardware that may be configured to perform one or more predetermined operations. In an embodiment, the database 102 may be realized through various technologies such as, but not limited to, relational databases, graph databases, NoSQL databases, document databases, key-value stores, column-oriented databases, data warehouses, and other technologies designed to facilitate data storage and retrieval. In an embodiment, the database 102 may be realized through Distributed Ledger Technology (DLT), and decentralized databases. Examples of the Distributed Ledger Technology (DLT) include but are not limited to Blockchain, and DAG (Directed Acyclic Graph). Examples of decentralized databases include but are not limited to IPFS (InterPlanetary File System), BigchainDB, and Swarm technology (a native base layer service of the Ethereum web3 stack).

The database 102 may be configured to transmit the data to the server 104 for data processing, via the communication network 106. In an embodiment, the database 102 may be configured to transmit the data to the server 104 and the backend server 108 at one or more locations for showcasing the pricing data of the assets.

A person with ordinary skills in the art will understand that the scope of the disclosure is not limited to the database 102 as a separate entity. In an embodiment, the functionalities of the database 102 can be integrated into the server 104.

In an embodiment, the server 104 may refer to a computing device or a software framework hosting an application or a software service. In an embodiment, the server 104 may be implemented to execute procedures such as, but not limited to, programs, routines, smart contracts, or scripts stored in one or more memories for supporting the hosted application or the software service. In an embodiment, the hosted application or the software service may be configured to perform one or more predetermined operations. The server 104 may be realized through various types of web or application servers such as, but are not limited to, a Python web server, a NodeJS web server, a Java application server, a .NET framework application server, a Base4 application server, a PHP framework application server, or any other application server framework. In an embodiment, the server 104 may be realized through various types of mobile application servers such as, but are not limited to, Backendless, Firebase, AWS (Amazon Web Services), and Microsoft Azure.

A person having ordinary skill in the art will appreciate that the scope of the disclosure is not limited to realizing the server 104, the backend server 108, and the client devices 110 as separate entities.

In one embodiment, the communication network 106 may correspond to a communication medium through which the database 102, the server 104, the backend server 108, and the client devices 110 may communicate with each other. Such communication may be performed, in accordance with various wired and wireless communication protocols. Examples of such wired and wireless communication protocols include but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, 2G, 3G, 4G cellular communication protocols, and/or Bluetooth (BT) communication protocols. The communication network 106 may include but is not limited to, the Internet, a cloud network, a Wireless Fidelity (Wi-Fi) network, a Wireless Local Area Network (WLAN), a Local Area Network (LAN), a telephone line (POTS), and/or a Metropolitan Area Network (MAN).

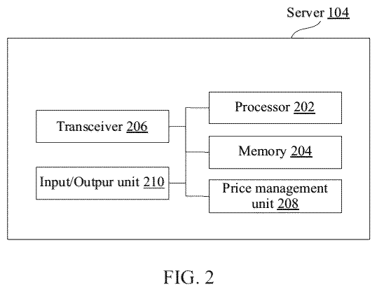

FIG. 2 is a block diagram that illustrates a server 104 configured to manage the pricing of one or more assets, in accordance with at least one embodiment. FIG. 2 is explained in conjunction with elements from FIG. 1. In an embodiment, the server 104 includes a processor 202, a memory 204, a transceiver 206, a price management unit 208, and an input/output unit 210. The processor 202 may be communicatively coupled to the memory 204, the transceiver 206, the price management unit 208, and the input/output unit 210. The transceiver 206 may be communicatively coupled to the communication network 106.

The processor 202 includes suitable logic, circuitry, interfaces, and/or code that may be configured to execute a set of instructions stored in the memory 204. The processor 202 may be implemented based on several processor technologies known in the art. The processor 202 works in coordination with the transceiver 206, the price management unit 208, and the input/output unit 210 to receive store, manage, and process data related to the pricing of the assets. Examples of the processor 202 include but are not limited to, an X86-based processor, a Reduced Instruction Set Computing (RISC) processor, an Application-Specific Integrated Circuit (ASIC) processor, a Complex Instruction Set Computing (CISC) processor, and/or other processors.

According to another aspect of the present disclosure, the processor 202 is configured to a) initiate a pricing management process for the one or more assets. The processor 202 is configured to b) enable the participation of one or more users. The processor 202 is configured to c) determine interest of the one or more users in purchasing the one or more assets. The processor 202 is configured to c1) allow the one or more users to exit the pricing management process upon determining disinterest of the one or more users in purchasing the one or more assets. In response to determining interest of the one or more users in purchasing, the processor 202 is configured to d) provide an option to the one or more users to reveal a concealed price through one or more of: a positive stripping process, and a negative stripping process. The processor 202 is configured to e) determine willingness of the one or more users to unveil the concealed price. In response to determine willingness of the one or more users to unveil the concealed price, the processor 202 is configured to f) require the one or more users to make a payment of a pre-determined fraction of the listed price to access the concealed price for a limited duration of ‘t’ seconds. In an embodiment, the pre-determined fraction of the listed price, whether fixed or variable, can be used to reveal a hidden price. It is important to note that “fraction” can represent either a static or dynamic value. The processor 202 is configured to g) execute the payment of the pre-determined fraction of credits in step f). The processor 202 is configured to h) record the credits in one or more of: a centralized ledger book, and a decentralized ledger book associated with a marketplace. The processor 202 is configured to i) adjust the price of the asset based on the accumulated credits from step g). The accumulated credits reduce the asset's price by a corresponding amount. The processor 202 is configured to j) verify whether the adjusted discounted price in step i) exceeds a predefined maximum discount limit set for the asset. The processor 202 is configured to k) enable continued participation of the one or more users in the positive stripping process while progressively reducing the asset's price with successive stripping actions upon determining that the predefined maximum discount limit has not been reached. The processor 202 is configured to l) render the positive stripping process with dynamic pricing void and commence the negative stripping process upon determining that the predefined maximum discount limit has been reached. The processor 202 is configured to m) implement the negative stripping process to prevent the discounted price from decreasing below the last stripped price obtained through the positive stripping process, thereby maintaining a static price. The processor 202 is configured to n) calculate surplus credits accrued through the negative stripping process in either the centralized ledger book or the decentralized ledger book. The processor 202 is configured to o) assign the surplus credits, if any, to a seller in exchange for a successful transfer of ownership of the asset to a buyer. The processor 202 is configured to p) inquire the one or more users about their intent to purchase the assets at a presently displayed discounted price. The processor 202 is configured to p1) allow the one or more users to exit the pricing management process upon determining the declination of the purchase by the one or more users. Responsive to the one or more users agreeing to the purchase, the processor 202 is configured to q) facilitate initiation of the purchase process for the one or more users. The processor 202 is configured to r) determine the availability of the assets during the purchase process to determine if the asset is still available for acquisition. The processor 202 is configured to s) verify the availability of sufficient credits with the one or more users upon determining if the asset is still available. The processor 202 is configured to t) confirm the transaction and transfer the accumulated credits, via the positive stripping process and the negative stripping processes, to the seller's account, upon payment approval. The processor 202 is configured to u) transfer ownership of the asset to the one of the one or more users who has completed the purchase process. In a scenario where multiple users initiate the “purchase” process for a “single asset”, only the transaction of the user whose payment is successfully processed will result in the acquisition of the product. For the remaining users, their transactions will fail, and they will not be able to obtain the product. The processor 202 is configured to e1) provide an option to the one or more users to acquire the asset at a listed price, and proceed to step r) to step u) upon determining unwillingness of the one or more users to unveil the concealed price. The processor 202 is configured to r1) exit the pricing management process with a display of a pre-stored message upon determining the unavailability of the asset. For example, the displayed pre-stored message can be “Asset has already been sold”.

The memory 204 comprises suitable logic, circuitry, interfaces, and/or code that may be configured to store the set of instructions, which are executed by the processor 202. In an embodiment, the memory 204 may be configured to store one or more programs, routines, or scripts that are executed in coordination with the processor 202. The memory 204 may be implemented based on a Random-Access Memory (RAM), a Read-Only Memory (ROM), a Hard Disk Drive (HDD), a storage server, and/or a Secure Digital (SD) card.

The transceiver 206 comprises suitable logic, circuitry, interfaces, and/or code that may be configured to receive the data related to the first unique client identifier, second unique client identifier, and the third unique client identifier from the database 102, via the communication network 106. The transceiver 206 may be further configured to transmit the data related to the first unique client identifier, second unique client identifier, and the third unique client identifier to one or more display screens of the backend server 108, via the communication network 106. The transceiver 206 may implement one or more known technologies to support wired or wireless communication with the communication network 106. In an embodiment, the transceiver 206 may include, but is not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. The transceiver 206 may communicate via wireless communication with networks, such as the Internet, an Intranet, and/or a wireless network, such as a cellular telephone network, a wireless local area network (LAN), and/or a metropolitan area network (MAN). The wireless communication may use any of a plurality of communication standards, protocols, and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The price management unit 208 comprises suitable logic, circuitry, interfaces, and/or code that may be configured to track users to identify if their digital activities are suspicious. The input/output unit 210 comprises suitable logic, circuitry, interfaces, and/or code that may be configured to provide one or more inputs to the server 104 during the creation and transmission of the data related to the pricing of the assets. The input/output unit 210 comprises various input and output devices that are configured to communicate with the processor 202. Examples of the input devices include, but are not limited to, a keyboard, a mouse, a touch screen, a microphone, a camera, and/or a docking station. Examples of the output devices include, but are not limited to, a display screen and/or a speaker.

A person skilled in the art will understand that the scope of the disclosure should not be limited to the generation, transmission, and processing of data related to the pricing of the assets based on the aforementioned factors and using the aforementioned techniques. Further, the examples provided in the specification are for illustrative purposes and should not be construed to limit the scope of the disclosure.

Definitions: The following terms shall have, for this application, the respective meanings set forth below.

“Credit(s)” or “Digital credit” refers to a representation of Virtual Tokens/Virtual Currency/Awarded Points/Purchased Points/ Rewards or similar references that could be used as a value in exchange for some service.

“Physical Credit” refers to physical currency, tradable good(s).

“Asset” refers to any product/ physical good(s)/service(s)/ virtual good(s)/online service(s) that could be traded in exchange for any form of credit(s).

“Marketplace” refers to a marketplace that is one where the sellers or vendors sell asset(s) to customers.

“Listed Price” refers to the value of the asset at which the seller wants to sell the asset.

“Stripping Mechanism” refers to a mechanism that can facilitate the reduction of the asset's listed price by spending a committed predetermined fractional value in the form of credit(s). The discounted price would be visible/accessible for a duration of time ‘t’ units.

“Positive Stripping Mechanism” refers to a dynamic pricing mechanism, where collected credit(s) have to be used to discount or lower the price of the asset up to a threshold value. In an embodiment, a positive stripping mechanism is a process of reducing the price of an asset with the help of the fractional amounts collected from the participant. In this process, the listed price of an asset would be discounted by an equivalent value of the total accumulated credits for that particular asset. The limitation of positive stripping is, that it could bring the asset price maximum discounted close to Zero percent but not beyond that. The asset price can never reach zero. In an exemplary embodiment, the maximum discount may be set at 99.99%, or in the case of expensive products, it may be extended to 99.999%. However, the threshold value will never reach 100%, ensuring that the discounted price can never reach zero. It is important to note that a maximum discount of 99.99% does not imply that the price must reach that level to trigger the ‘Negative Stripping Mechanism.’ This specification further outlines various scenarios for maximum discount computations, as follows: 1) If the ‘predetermined fraction’ is set at 1%, the price can receive a maximum discount of 99%, at which point the ‘Negative Stripping Mechanism’ will be initiated. 2) If the ‘predetermined fraction’ is 0.1%, the price can be discounted by up to 99.9%, triggering the ‘Negative Stripping Mechanism.’ 3) When the ‘predetermined fraction’ is 0.01%, the maximum discount allowed is 99.99%, after which the ‘Negative Stripping Mechanism’ comes into play. 4) If the ‘predetermined fraction’ is 5%, the price can be discounted by a maximum of 95%, and the ‘Negative Stripping Mechanism’ will activate accordingly.

“Negative Stripping Mechanism” refers to an extension of the positive stripping mechanism. Once the maximum discount limit (threshold value for the listed price) is reached, the price doesn't go lower and becomes static. The collection of CREDIT(S) could be more than the equivalent value of the listed price. The extra collected credit(s) would go to the Seller and Marketplace.

“Consumer” or “Customer” or “User” or “Buyer” or “Seller” refers to anyone ready to buy/sell the asset in exchange for credit(s).

In the present pricing mechanism user(s)/participant(s) can buy assets at the guaranteed lowest price with respect to the product's listed price. The user has to spend/commit a predefined fractional value to unveil/unlock/unhide the guaranteed lowest price for a specific predetermined duration (time ‘t’ units). During time t, the user has access to purchase or buy the asset at the shown discounted price amount. If there are multiple users or participants in the same duration of time ‘t’, the quickest decision maker who also completes the transaction before anyone else will get the asset.

For Example:
Let's assume Platform: STRIPTO NFT Marketplace (SNM)
Asset: Non-Fungible Token (NFT)
Asset Price: 1000 USD
Credit(s): $VIRTUAL TOKEN ($VT)
Credit Price: 1 $VT=1 USD
Positive Stripping %: 1% (of the listed price)
Time Duration (t): 15 Seconds
Maximum % Discount Limit: 99%
Sale Fee for Positive Stripping: 0%
Sale Fee for Negative Stripping: 5%

In an exemplary embodiment, stripping action refers to a situation when a user commits $VT worth 1% of the listed price of the asset to unlock the hidden price for 15 seconds. Credits required per stripping action: 10 $VT i.e., 1% of the listed price.

Participant refers to any visitor/user on the marketplace who wants to buy the asset.

Asset listing refers to a process of allowing/displaying something over the marketplace for sale.

Listing price refers to the price of an asset set by the seller over the marketplace.

Pricing mechanism or hidden price refers to a process that helps the user unlock the hidden price by paying a fraction of the credits. As per the proposed mechanism, this hidden price would always be less than the listed price in the marketplace.

Credit accumulation refers to a process that accumulates all the credits participants are paying to unveil the hidden price. These credits compensate the price of the asset to the seller.

For implementation, the system of the present invention must include user participation, assets should be listed on the marketplace, valid credits available to unlock the hidden price, presence of positive and negative stripping mechanisms (price reduction mechanism), credit accumulation for the price reduction, the dynamic price for positive stripping, the static price for negative stripping, transfer of credits to the seller, and asset ownership transfer to the buyer from the seller.

Optionally, the system of the present invention may include various other components such as simultaneous stripping (multi-user participation), the asset may be sold at the listed price, the user may buy the asset at a discounted price, and service charges.

The origination/individual can change pick any name for the credits and could allow the users to take advantage of these credits to lower the price. Transparency for negative stripping can be disabled to allow negative stripping, however, the seller will see the positive strip value only and profit will go to the marketplace.

The asset and credits could be used over the marketplace and the stripping mechanism could be used to reduce the asset price to benefit the buyers and sellers.

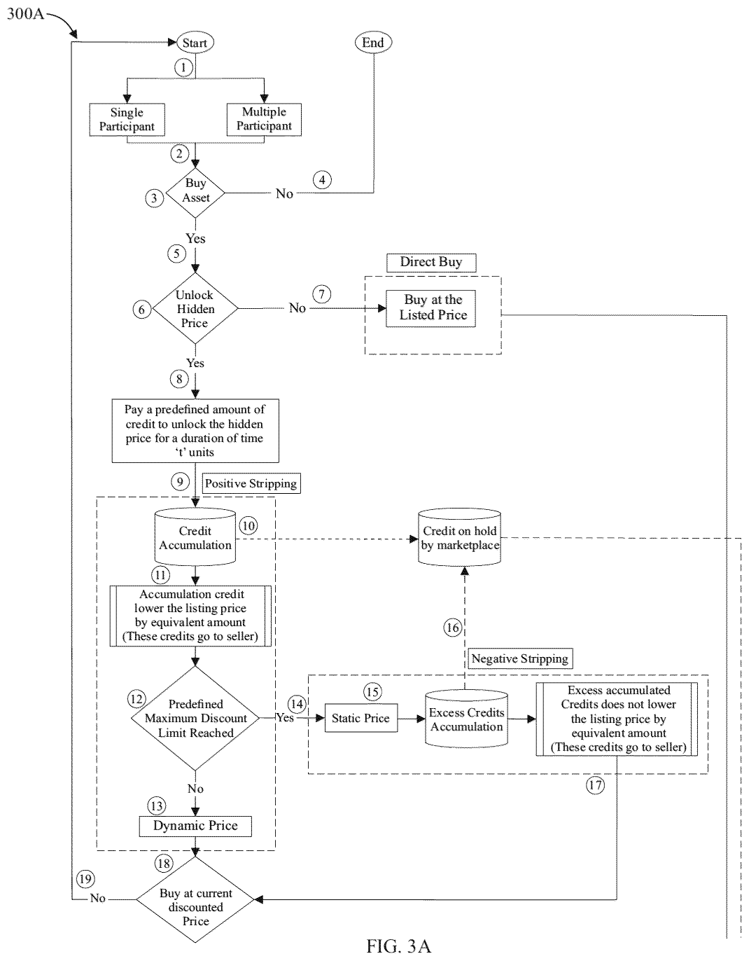

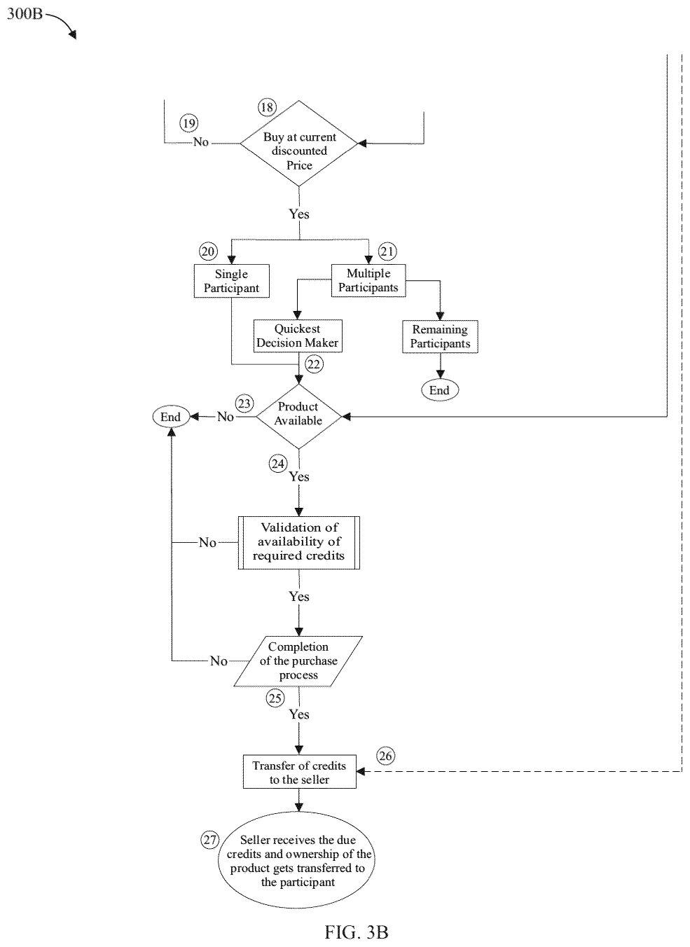

FIGS. 3A-3B are operational flowcharts 300A-300B of the present method, in accordance with at least one embodiment. At block 1, the process commences. In block 2, the process allows for participation by either a single user or multiple users. Moving on to block 3, a critical question arises: do the participants wish to purchase the product? If the answer in block 3 is NO, the participants are free to exit the process, as stated in block 4. However, if the participants answer YES to the question in block 3, they enter a crucial decision point in block 5. Here, they are presented with the option to unlock the hidden price through a positive stripping process. Block 6 follows, prompting participants to decide whether or not they wish to proceed with unlocking this hidden price. If the answer in block 6 is NO, participants have an alternative: they can opt to purchase the asset at the listed price, as explained in block 7. On the other hand, if participants answer YES in block 6, they move forward to block 8, where they must pay a predetermined fraction of the listed price to unlock the hidden price. The specifics of this payment are clarified in block 9, where the pre-determined fraction, referred to as “credits,” is transferred. These credits are logged and tracked in the marketplace's centralized ledger book in block 10. As participants accumulate credits, the asset's price decreases by an equivalent amount, as stated in block 11. Block 12 monitors this process by checking if the current discounted amount has reached the predefined maximum discount limit set for the asset. Should the maximum discount limit not yet be reached, participants continue the positive stripping process, sequentially lowering the asset's price with each stripping action, as described in block 13. However, if the maximum discount limit has been reached, as indicated in block 14, the positive stripping process with dynamic pricing is terminated, and the negative stripping process is initiated. Block 15 underscores that the negative stripping process maintains the asset's price at the last stripped price attained by the positive stripping process, rendering it static. In block 16, the system calculates any excess credits collected, and these credits are allocated, as depicted in block 17, to the seller in exchange for successfully transferring ownership of the asset to the buyer. Block 18 probes once more, asking if the participants want to buy the asset at the currently offered or visible discounted price. If the response is NO, the user can exit the process, as detailed in block 19. However, if participants affirm their desire to make the purchase, the process advances. For single participants, as explained in block 20, they can proceed to initiate the buying process after expressing their intent. Block 21 highlights that for multiple participants, each has the opportunity to initiate the buying process as well. Block 22 accounts for the possibility of multiple participants participating simultaneously, with the process checking for product availability during the buying process. In block 23, if the product is no longer available, the process concludes with the message “Asset has already been sold.” If, however, the product is still available, block 24 checks for the availability of sufficient credits at the participants' end. Assuming there are enough credits, the process moves to block 25, where payment approval is sought. Following payment approval, the system proceeds to confirm the transaction, per block 25. The credits amassed through the positive and negative stripping processes are transferred to the seller's account in block 26. Finally, in block 27, ownership of the asset is officially transferred to the buyer or participant.

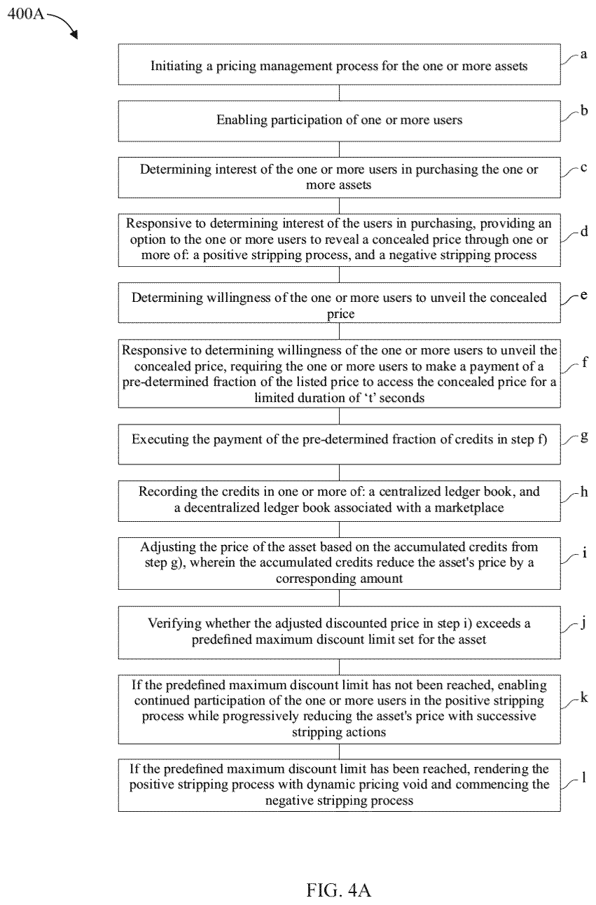

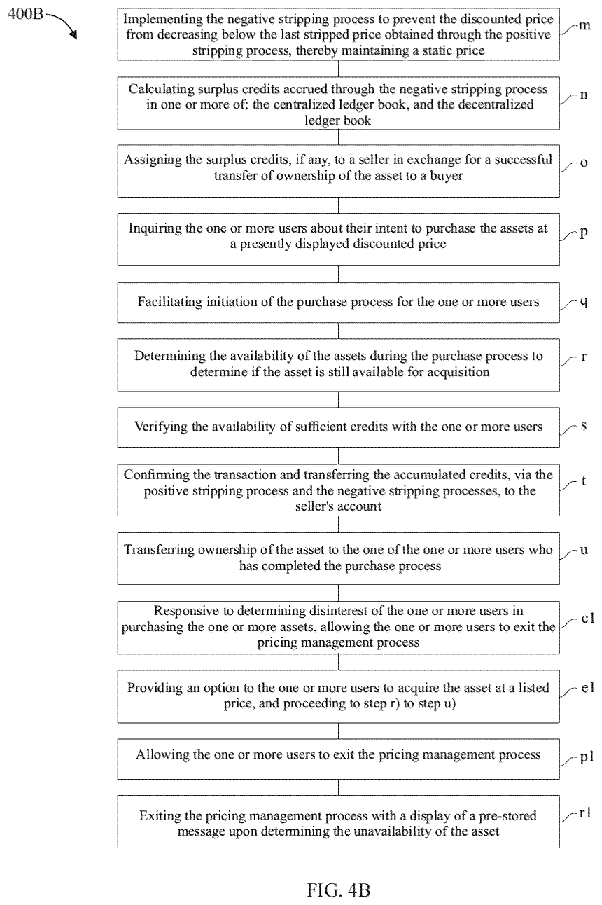

FIGS. 4A-4B illustrate a flowchart 400 of a method for managing the pricing of one or more assets, in accordance with at least one embodiment. The method includes a step of a) initiating, by a processor, a pricing management process for the one or more assets. The method includes a step of b) enabling, by the processor, participation of one or more users. The method includes a step of c) determining, by the processor, interest of the one or more users in purchasing the one or more assets. The method includes a step of d) responsive to determining, by the processor, interest of the one or more users in purchasing, providing an option to the one or more users to reveal a concealed price through one or more of: a positive stripping process, and a negative stripping process. The method includes steps of: e) determining, by the processor, willingness of the one or more users to unveil the concealed price; f) responsive to determining, by the processor, willingness of the one or more users to unveil the concealed price, requiring the one or more users to make a payment of a pre-determined fraction of the listed price to access the concealed price for a limited duration of ‘t’ seconds; and g) executing, by the processor, the payment of the pre-determined fraction of credits in step f). The method includes a step of h) recording, by the processor, the credits in one or more of: a centralized ledger book, and a decentralized ledger book associated with a marketplace. The method includes a step of i) adjusting, by the processor, the price of the asset based on the accumulated credits from step g), wherein the accumulated credits reduce the asset's price by a corresponding amount. The method includes a step of j) verifying, by the processor, whether the adjusted discounted price in step i) exceeds a predefined maximum discount limit set for the asset. The method includes a step of k) if the predefined maximum discount limit has not been reached, enabling, by the processor, continued participation of the one or more users in the positive stripping process while progressively reducing the asset's price with successive stripping actions. The method includes a step of l) if the predefined maximum discount limit has been reached, rendering, by the processor, the positive stripping process with dynamic pricing void and commencing the negative stripping process. The method includes a step of m) implementing, by the processor, the negative stripping process to prevent the discounted price from decreasing below the last stripped price obtained through the positive stripping process, thereby maintaining a static price. The method includes a step of n) calculating, by the processor, surplus credits accrued through the negative stripping process in one or more of: the centralized ledger book, and the decentralized ledger book. The method includes a step of o) assigning, by the processor, the surplus credits, if any, to a seller in exchange for a successful transfer of ownership of the asset to a buyer. The method includes a step of p) inquiring, by the processor, the one or more users about their intent to purchase the assets at a presently displayed discounted price. When the one or more users agree to the purchase, the method includes a step of q) facilitating, by the processor, initiation of the purchase process for the one or more users. The method includes a step of r) determining, by the processor, the availability of the assets during the purchase process to determine if the asset is still available for acquisition. If the asset is still available, the method includes a step of s) verifying, by the processor, the availability of sufficient credits with the one or more users. Upon payment approval, the method includes a step of t) confirming the transaction, by the processor, and transferring the accumulated credits, via the positive stripping process and the negative stripping processes, to the seller's account.

The method includes a step of u) transferring, by the processor, ownership of the asset to the one of the one or more users who has completed the purchase process. The method includes a step of c1) responsive to determining, by the processor, disinterest of the one or more users in purchasing the one or more assets, allowing the one or more users to exit the pricing management process. Responsive to determining unwillingness of the one or more users to unveil the concealed price, the method includes a step of e1), providing an option to the one or more users to acquire the asset at a listed price, and proceeding to step r) to step u). Responsive to determining the declination of the purchase by the one or more users, the method includes a step of: p1) allowing the one or more users to exit the pricing management process. If the asset is unavailable, the method includes a step of: r1) exiting the pricing management process with a display of a pre-stored message upon determining the unavailability of the asset.

By Socially Reducing the price of the listed asset will solve the purchase problem of a highly listed asset thereby reducing the value of the asset.

A regular market auction is usually designed to benefit only the seller with the mechanism that increases the value of the asset as the interest in the asset increases. This conventional mechanism does not favor the buyer as the price of the asset increases. The proposed unique pricing mechanism benefits both the seller and the buyer by reducing the asset price for the buyer with the “Positive Stripping Pricing Mechanism”, along with the chances of increasing the sale value of the asset by the “Negative Stripping Pricing Mechanism”. Thus, giving the seller a higher amount sold and the buyer with a lower purchase amount.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided to illustrate various embodiments and should in no way be construed to limit the claims.

In an alternative embodiment, the present invention can create software, a business model, and an auction mechanism.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, the use of the singular article such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method for managing pricing of one or more assets, comprising:
a) initiating, by a processor, a pricing management process for the one or more assets;
b) enabling, by the processor, participation of one or more users;
c) determining, by the processor, interest of the one or more users in purchasing the one or more assets;
d) responsive to determining, by the processor, interest of the one or more users in purchasing, providing an option to the one or more users to reveal a concealed price through one or more of: a positive stripping process, and a negative stripping process;
e) determining, by the processor, willingness of the one or more users to unveil the concealed price;
f) responsive to determining, by the processor, willingness of the one or more users to unveil the concealed price, requiring the one or more users to make a payment of a pre-determined fraction of the listed price to access the concealed price for a limited duration of ‘t’ seconds;
g) executing, by the processor, the payment of the pre-determined fraction of credits in step f);
h) recording, by the processor, the credits in one or more of: a centralized ledger book, and a decentralized ledger book associated with a marketplace;
i) adjusting, by the processor, the price of the asset based on the accumulated credits from step g), wherein the accumulated credits reduce the asset's price by a corresponding amount;
j) verifying, by the processor, whether the adjusted discounted price in step i) exceeds a predefined maximum discount limit set for the asset;
k) if the predefined maximum discount limit has not been reached, enabling, by the processor, continued participation of the one or more users in the positive stripping process while progressively reducing the asset's price with successive stripping actions;
l) if the predefined maximum discount limit has been reached, rendering, by the processor, the positive stripping process with dynamic pricing void and commencing the negative stripping process;
m) implementing, by the processor, the negative stripping process to prevent the discounted price from decreasing below the last stripped price obtained through the positive stripping process, thereby maintaining a static price;
n) calculating, by the processor, surplus credits accrued through the negative stripping process in one or more of: the centralized ledger book, and the decentralized ledger book;
o) assigning, by the processor, the surplus credits, if any, to a seller in exchange for a successful transfer of ownership of the asset to a buyer;
p) inquiring, by the processor, the one or more users about their intent to purchase the assets at a presently displayed discounted price;
q) responsive to the one or more users agreeing to the purchase, facilitating, by the processor, initiation of the purchase process for the one or more users;
r) determining, by the processor, the availability of the assets during the purchase process to determine if the asset is still available for acquisition;
s) if the asset is still available, verifying, by the processor, the availability of sufficient credits with the one or more users;
t) upon payment approval, confirming the transaction, by the processor, and transferring the accumulated credits, via the positive stripping process and the negative stripping processes, to the seller's account; and
u) transferring, by the processor, ownership of the asset to the one of the one or more users who has completed the purchase process.

2. The method according to claim 1, comprises a step of: c1) responsive to determining, by the processor, disinterest of the one or more users in purchasing the one or more assets, allowing the one or more users to exit the pricing management process.

3. The method according to claim 1, comprises a step of: e1) responsive to determining, by the processor, unwillingness of the one or more users to unveil the concealed price, providing an option to the one or more users to acquire the asset at a listed price, and proceeding to step r) to step u).

4. The method according to claim 1, comprises a step of: p1) responsive to determining, by the processor, declination of the purchase by the one or more users, allowing the one or more users to exit the pricing management process.

5. The method according to claim 1, comprises a step of: r1) if the asset is unavailable, exiting, by the processor, the pricing management process with a display of a pre-stored message upon determining unavailability of the asset.

6. A system for managing pricing of one or more assets, comprising:
a processor; and
a memory communicatively coupled to the processor, wherein the memory stores a plurality of instructions, which, on execution, causes the processor to:
a) initiate a pricing management process for the one or more assets;
b) enable participation of one or more users;
c) determine interest of the one or more users in purchasing the one or more assets;
d) responsive to determining interest of the one or more users in purchasing, provide an option to the one or more users to reveal a concealed price through one or more of: a positive stripping process, and a negative stripping process;
e) determine willingness of the one or more users to unveil the concealed price;
f) responsive to determining willingness of the one or more users to unveil the concealed price, require the one or more users to make a payment of a pre-determined fraction of the listed price to access the concealed price for a limited duration of ‘t’ seconds;
g) execute the payment of the pre-determined fraction of credits in step f);
h) record the credits in one or more of: a centralized ledger book, and a decentralized ledger book associated with a marketplace;
i) adjust the price of the asset based on the accumulated credits from step g), wherein the accumulated credits reduce the asset's price by a corresponding amount;
j) verify whether the adjusted discounted price in step i) exceeds a predefined maximum discount limit set for the asset;
k) if the predefined maximum discount limit has not been reached, enable continued participation of the one or more users in the positive stripping process while progressively reducing the asset's price with successive stripping actions;
l) if the predefined maximum discount limit has been reached, render the positive stripping process with dynamic pricing void and commence the negative stripping process;
m) implement the negative stripping process to prevent the discounted price from decreasing below the last stripped price obtained through the positive stripping process, thereby maintaining a static price;
n) calculate surplus credits accrued through the negative stripping process in one or more of: the centralized ledger book, and the decentralized ledger book;
o) assign the surplus credits, if any, to a seller in exchange for a successful transfer of ownership of the asset to a buyer;
p) inquire the one or more users about their intent to purchase the assets at a presently displayed discounted price;
q) responsive to the one or more users agreeing to the purchase, facilitate initiation of the purchase process for the one or more users;
r) determine the availability of the assets during the purchase process to determine if the asset is still available for acquisition;
s) if the asset is still available, verify the availability of sufficient credits with the one or more users;
t) upon payment approval, confirm the transaction and transfer the accumulated credits, via the positive stripping process and the negative stripping processes, to the seller's account; and
u) transfer ownership of the asset to the one of the one or more users who has completed the purchase process.

7. The system according to claim 6, wherein the processor is configured to c1) allow the one or more users to exit the pricing management process upon determining disinterest of the one or more users in purchasing the one or more assets.

8. The system according to claim 6, wherein the processor is configured to e1) provide an option to the one or more users to acquire the asset at a listed price, and proceed to step r) to step u) upon determining unwillingness of the one or more users to unveil the concealed price.

9. The system according to claim 6, wherein the processor is configured to p1) allow the one or more users to exit the pricing management process upon determining declination of the purchase by the one or more users.

10. The system according to claim 6, wherein the processor is configured to r1) exit the pricing management process with a display of a pre-stored message upon determining the unavailability of the asset.

11. A non-transitory computer-readable storage medium in a distributed computing system, the non-transitory computer-readable storage medium having instructions stored thereupon which, when executed by a processor, cause the processor to:
a) initiate a pricing management process for the one or more assets;
b) enable participation of one or more users;
c) determine interest of the one or more users in purchasing the one or more assets;
d) responsive to determining interest of the one or more users in purchasing, provide an option to the one or more users to reveal a concealed price through one or more of: a positive stripping process, and a negative stripping process;
e) determine willingness of the one or more users to unveil the concealed price;
f) responsive to determining willingness of the one or more users to unveil the concealed price, require the one or more users to make a payment of a pre-determined fraction of the listed price to access the concealed price for a limited duration of ‘t’ seconds;
g) execute the payment of the pre-determined fraction of credits in step f);
h) record the credits in one or more of: a centralized ledger book, and a decentralized ledger book associated with a marketplace;
i) adjust the price of the asset based on the accumulated credits from step g), wherein the accumulated credits reduce the asset's price by a corresponding amount;
j) verify whether the adjusted discounted price in step i) exceeds a predefined maximum discount limit set for the asset;
k) if the predefined maximum discount limit has not been reached, enable continued participation of the one or more users in the positive stripping process while progressively reducing the asset's price with successive stripping actions;
l) if the predefined maximum discount limit has been reached, render the positive stripping process with dynamic pricing void and commence the negative stripping process;
m) implement the negative stripping process to prevent the discounted price from decreasing below the last stripped price obtained through the positive stripping process, thereby maintaining a static price;
n) calculate surplus credits accrued through the negative stripping process in one or more of: the centralized ledger book, and the decentralized ledger book;
o) assign the surplus credits, if any, to a seller in exchange for a successful transfer of ownership of the asset to a buyer;
p) inquire the one or more users about their intent to purchase the assets at a presently displayed discounted price;
q) responsive to the one or more users agreeing to the purchase, facilitate initiation of the purchase process for the one or more users;
r) determine the availability of the assets during the purchase process to determine if the asset is still available for acquisition;
s) if the asset is still available, verify the availability of sufficient credits with the one or more users;
t) upon payment approval, confirm the transaction and transfer the accumulated credits, via the positive stripping process and the negative stripping processes, to the seller's account; and
u) transfer ownership of the asset to the one of the one or more users who has completed the purchase process.

12. The non-transitory computer-readable storage medium according to claim 11, wherein the processor is configured to c1) allow the one or more users to exit the pricing management process upon determining disinterest of the one or more users in purchasing the one or more assets.

13. The non-transitory computer-readable storage medium according to claim 11, wherein the processor is configured to e1) provide an option to the one or more users to acquire the asset at a listed price, and proceeding to step r) to step u) upon determining unwillingness of the one or more users to unveil the concealed price.

14. The non-transitory computer-readable storage medium according to claim 11, wherein the processor is configured to p1) allows the one or more users to exit the pricing management process upon determining the declination of the purchase by the one or more users.

15. The non-transitory computer-readable storage medium according to claim 11, wherein the processor is configured to r1) exit the pricing management process with a display of a pre-stored message upon determining the unavailability of the asset.
